(19) United States
(12) Patent Application Publication
(10) Pub. No.: US 2025/0285214 A1
(43) Pub. Date: Sep. 11, 2025

(54) RGBIR IMAGE PROCESSING SYSTEM

(71) Applicant: Himax Technologies Limited, Tainan City (TW)

(72) Inventors: Wei-Chieh Yang, Tainan City (TW); Po-Chang Chen, Tainan City (TW)

(21) Appl. No.: 18/596,269

(22) Filed: Mar. 5, 2024

(51) Int. Cl. G06T 3/4015; G06T 5/92; G06V 10/56; H04N 9/73

(52) U.S. Cl. CPC G06T 3/4015; G06T 5/92; G06V 10/56; H04N 9/73; G06T 2207/10024; G06T 2207/10048

(57) ABSTRACT

A red, green, blue and infrared (RGBIR) image processing system includes an RGBIR-Bayer converter that converts RGBIR raw data to Bayer raw data, and a Bayer-RGB converter that converts the Bayer raw data to RGB color data. The Bayer-RGB converter includes a color adjusting device that adjusts color information of the Bayer raw data, thereby generating adjusted data.

### BACKGROUND OF THE INVENTION

### 1. Field of the Invention

The present invention generally relates to an image processing system, and more particularly to a red, green, blue and infrared (RGBIR) image processing system.

### 2. Description of Related Art

A smart camera is a machine vision system that can extract application-specific information from captured images and generate event descriptions or make decisions that are used in an intelligent and automated system. Smart cameras are capable of performing a wide range of tasks, including object detection, tracking and recognition, barcode reading, and optical character recognition (OCR). They can also be used for quality control, inspection, and measurement. Smart cameras are often used in industrial automation, robotics, and machine vision applications.

Artificial intelligence is a key component of smart cameras, which combine conventional imaging technologies with advanced algorithms to deliver high-quality images for human inspection and real-time image analysis. Smart cameras can perform tasks such as face recognition, object detection, motion tracking, and scene understanding, among others, without requiring external processing units or human intervention.

A co-processor is a device that works alongside a main system-on-chip (SoC) in a smart camera system. The co-processor handles the computation of image analytics, which requires low resolution images. The main SoC, on the other hand, processes high resolution images for human viewing or advanced analytics. This way, the co-processor reduces the workload of the main SoC and improves the performance of the smart camera system.

One of the benefits of using the co-processor is that it enables constant sensing without draining the battery of the system. The co-processor can detect relevant events and activate the SoC only when needed. This way, the system can save power and extend its operation time. For example, a home surveillance system can use the co-processor to monitor the presence of humans in the area. When the co-processor senses a human, it can trigger the SoC to start recording video. This reduces the amount of unnecessary video data and power consumption of the system.

One of the emerging technologies in the field of image processing is the RGB-Infrared (RGBIR) sensor, which can capture both visible and invisible light. Unlike conventional sensors that only have red, green, and blue pixels, an RGB-IR sensor also has an infrared pixel that can detect heat radiation. This makes it possible to create images that are not affected by the ambient lighting conditions, such as darkness or fog. RGB-IR sensors are especially useful for applications that require reliable and safe vision performance in day and night scenarios, such as security cameras, autonomous vehicles, or medical imaging.

The RGBIR sensor can provide enhanced imaging capabilities for various applications. However, such sensor output does not map well to conventional image signal processor (ISP) due to the presence of the additional IR pixels. Therefore, there is a need for an additional processing block in order to generate a color image from the RGBIR data. A scheme (e.g., U.S. Pat. No. 11,836,888) proposes a method that converts the RGBIR data to Bayer data and applies a conventional ISP pipeline to generate the color image.

A common problem with RGBIR image sensors is that they do not have a good way of reducing the resolution of the data they capture. This can be a challenge when both high and low-resolution data are needed, for example in smart camera systems. These systems may not be able to adjust the RGBIR image sensors to produce the right data for different purposes.

A need has thus arisen to simplify the co-processor's ISP to overcome the constraints of its hardware resources and to suit the lower image quality demand for image analytics (compared to human viewing). The goal of this simplification is to reduce memory consumption and computation cost.

### SUMMARY OF THE INVENTION

In view of the foregoing, it is an object of the embodiment of the present invention to provide an RGBIR image processing system capable of processing RGBIR images, which are captured by a smart camera system with a co-processor. The proposed method converts the RGBIR images into RGB color images, which are more compatible with existing image analysis algorithms.

According to one embodiment, a red, green, blue and infrared (RGBIR) image processing system includes an RGBIR-Bayer converter and a Bayer-RGB converter. The RGBIR-Bayer converter converts RGBIR raw data to Bayer raw data. The Bayer-RGB converter converts the Bayer raw data to RGB color data. The Bayer-RGB converter includes a color adjusting device that adjusts color information of the Bayer raw data, thereby generating adjusted data

In one embodiment, the RGBIR-Bayer converter includes a subsampler that decimates the RGBIR raw data by odd number M to keep only every RGBIR raw data at M-th row and M-th column.

In another embodiment, the color adjusting device adjusts color information of the Bayer raw data by performing color processing, tone processing or both on the Bayer raw data.

### BRIEF DESCRIPTION OF THE DRAWINGS

FIG. 1 shows a block diagram illustrating a red, green, blue and infrared (RGBIR) image processing system according to one embodiment of the present invention;

FIG. 2 shows exemplary subsampled data decimated by the subsampler of FIG. 1 adopting the odd-numbered subsampling scheme;

FIG. 3 shows exemplary subsampled data not adopting the odd-numbered subsampling scheme; and

FIG. 4 shows an exemplary 2×2 Bayer pattern subjected to color correction.

### DETAILED DESCRIPTION OF THE INVENTION

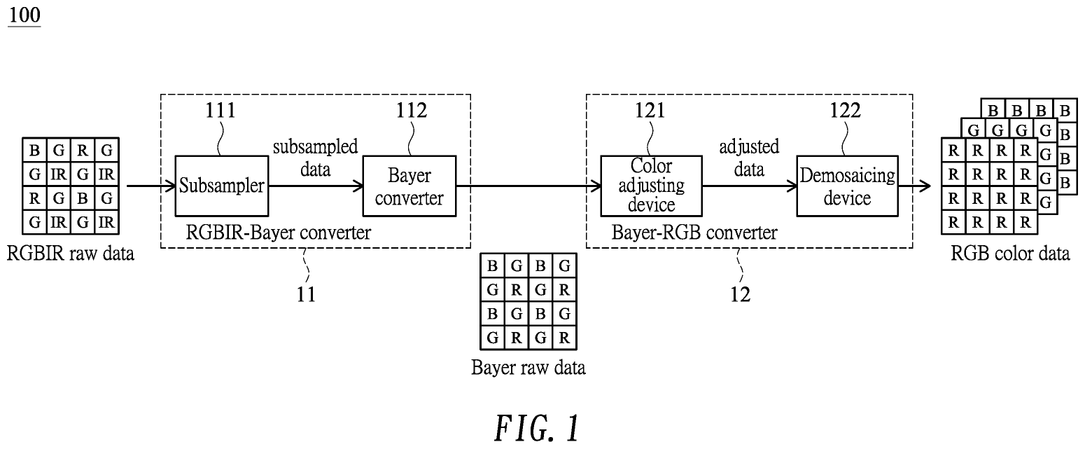

FIG. 1 shows a block diagram illustrating a red, green, blue and infrared (RGBIR) image processing system 100 according to one embodiment of the present invention. The RGBIR image processing system 100 of FIG. 1 may be adapted to an always-on co-processor (e.g., image signal processor or ISP) in a smart camera system to wake a system-on-chip (SoC) only when a relevant event occurs.

In the embodiment, the RGBIR image processing system 100 may include an RGBIR-Bayer converter 11 configured to convert RGBIR raw data to Bayer raw data. Specifically, the RGBIR raw data is an image data captured by an (RGBIR) image sensor covered with an RGBIR filter array having an RGBIR pattern, as exemplified in the 4×4 pattern in FIG. 1, which is half green, one quarter infrared, one eighth red and one eighth blue. The Bayer raw data is an image data arranged in Bayer pattern, as exemplified in the 4×4 pattern in FIG. 1, which is half green, one quarter red and one quarter blue.

In the embodiment, the RGBIR-Bayer converter 11 may include a subsampler 111 configured to subsample the RGBIR raw data to generate subsampled data, which preserves the RGBIR pattern. According to one aspect of the embodiment, an odd-numbered subsampling scheme is adopted. Specifically, the subsampler 111 decimates the RGBIR raw data by odd number M (e.g., 3, 5 or 7) to keep only every RGBIR raw data at M-th row and M-th column. Equivalently speaking, only every RGBIR raw data in the upper left corner of M×M matrix is kept as the subsampled data.

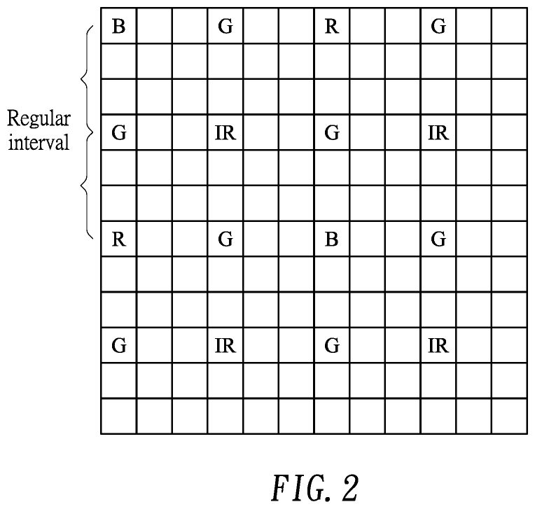

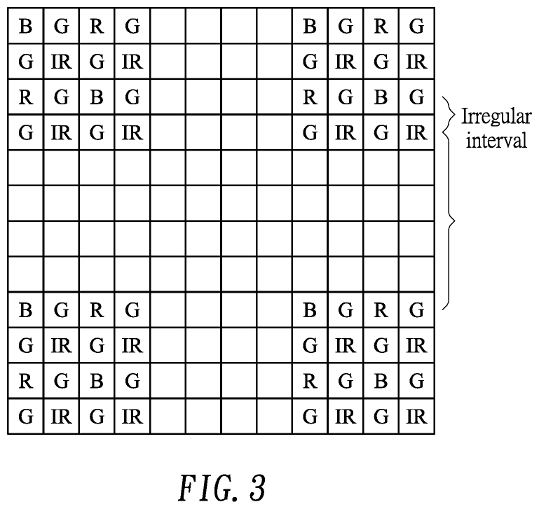

FIG. 2 shows exemplary subsampled data decimated by the subsampler 111 of FIG. 1 adopting the odd-numbered subsampling scheme with odd number 3 to keep only every RGBIR raw data at third row and third column, thereby preserving the RGBIR pattern. As shown in FIG. 2, adjacent subsampled data are regularly spaced. FIG. 3 shows exemplary subsampled data not adopting the odd-numbered subsampling scheme of the embodiment. As shown in FIG. 3, adjacent subsampled data are irregularly spaced.

Referring back to FIG. 1, the RGBIR-Bayer converter 11 of the embodiment may include a Bayer converter 112 configured to convert the subsampled data to the Bayer raw data (with the Bayer pattern). Conventional techniques of converting the subsampled data to the Bayer raw data may be adopted, detail of which may, for example, be referred to U.S. Pat. No. 11,836,888, contents of which are incorporated herein by reference.

According to the above, prior to the conversion performed by the Bayer converter 112, the subsampler 111 reduces data size by using the odd-numbered subsampling scheme to address challenges related to high resolution of typical RGBIR sensors. This reduction is crucial to manage memory usage and computation costs for image analytics, as the main SoC typically requires high resolution RGBIR data for human viewing or advanced analytics.

In the embodiment, the RGBIR image processing system 100 may include a Bayer-RGB converter 12 configured to convert the Bayer raw data to RGB color data (or image). According to another aspect of the embodiment, the Bayer-RGB converter 12 may include a color adjusting device 121 configured to adjust color information of the Bayer raw data, thereby generating adjusted data. In one embodiment, the color adjusting device 121 may perform color processing and tone processing on the Bayer raw data. The color processing may, for example, include white balance and color correction. White balance is a process of adjusting colors (e.g., color temperature) in an image to make it appear more natural by removing color casts caused by the lighting conditions. Color correction, on the other hand, is a process of adjusting colors in an image to achieve a desired look or mood. The tone processing may, for example, include gamma correction. Gamma correction is a process of adjusting brightness of an image, and is commonly used to correct the brightness of images that appear too dark or too bright.

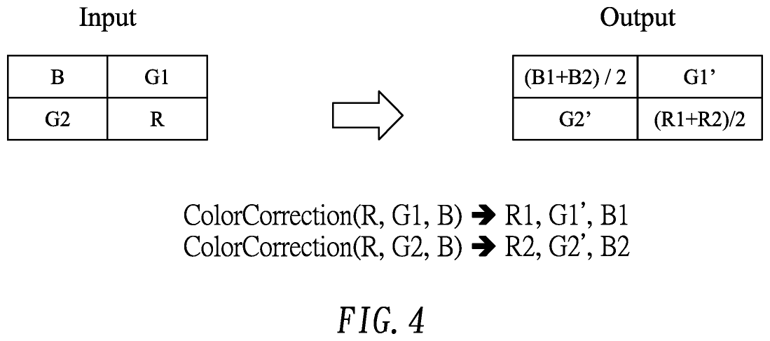

For per-pixel process like white balance and gamma correction, the computation is performed individually for each pixel based on its color channel. For process requiring RGB information like color correction, the processing is done for each 2×2 Bayer pattern. FIG. 4 shows an exemplary 2×2 Bayer pattern subjected to color correction. In the embodiment, color correction is executed twice for every 2×2 Bayer pattern, once for each green pixel G1 or G2. The output red and blue pixel values are then derived by averaging the two corrected red values (R1 and R2) and the two blue pixel values (B1 and B2).

In another embodiment, the color adjusting device 121 may perform only tone processing on the Bayer raw data. This approach is chosen because tone-related processing is found to be most significant in enhancing image analytics.

It is appreciated that the color processing and/or the tone processing of the embodiment is performed on the Bayer raw data, instead of being performed on RGB color data as in the conventional systems, thereby effectively minimizing computational costs for the reasons that the data size of the RGB color data is three times that of the Bayer raw data.

The Bayer-RGB converter 12 of the embodiment may include a demosaicing device 122 configured to convert the adjusted data to the RGB color data in order to reconstruct a full color image. Conventional demosaicing techniques may be adopted, detail of which may, for example, be referred to U.S. Pat. No. 11,836,888, contents of which are incorporated herein by reference.

Although specific embodiments have been illustrated and described, it will be appreciated by those skilled in the art that various modifications may be made without departing from the scope of the present invention, which is intended to be limited solely by the appended claims.

What is claimed is:

1. A red, green, blue and infrared (RGBIR) image processing system, comprising:
an RGBIR-Bayer converter that converts RGBIR raw data to Bayer raw data; and
a Bayer-RGB converter that converts the Bayer raw data to RGB color data;
wherein the Bayer-RGB converter comprises a color adjusting device that adjusts color information of the Bayer raw data, thereby generating adjusted data.

2. The system of claim 1, further comprising an image sensor covered with an RGBIR filter array for generating the RGBIR raw data, the RGBIR filter array having an RGBIR pattern, which is half green, one quarter infrared, one eighth red and one eighth blue.

3. The system of claim 2, wherein the RGBIR-Bayer converter comprises a subsampler that subsamples the RGBIR raw data to generate subsampled data, which preserves the RGBIR pattern.

4. The system of claim 3, wherein the subsampler decimates the RGBIR raw data by odd number M to keep only every RGBIR raw data at M-th row and M-th column.

5. The system of claim 3, wherein the RGBIR-Bayer converter comprises a Bayer converter that converts the subsampled data to the Bayer raw data.

6. The system of claim 1, wherein the color adjusting device performs color processing, tone processing or both on the Bayer raw data.

7. The system of claim 6, wherein the color processing comprises white balance and color correction.

8. The system of claim 7, wherein the color correction is executed twice for every 2×2 Bayer pattern, once for each green pixel, thereby generating two corrected red values and two blue pixel values; and the output red and blue pixel values are then derived by averaging the two corrected red values and the two blue pixel values.

9. The system of claim 6, wherein the tone processing comprises gamma correction.

10. The system of claim 1, wherein the color adjusting device performs only tone processing on the Bayer raw data.

11. The system of claim 1, wherein the Bayer-RGB converter comprises a demosaicing device that converts the adjusted data to the RGB color data.
